(19) United States
(12) Patent Application Publication
(10) Pub. No.: US 2020/0044463 A1
(43) Pub. Date: Feb. 6, 2020

(54) UNMANNED AERIAL VEHICLE AND UNMANNED AERIAL VEHICLE AUTOMATIC CHARGING DEVICE

(71) Applicant: JINHEUNGTECH CO., LTD., Daegu (KR)

(72) Inventors: Dae Nyeon KIM, Gyeongsan-si, Gyeongsangbuk-do (KR); Sang Sik KIM, Daegu (KR); Dong Hyuk LEE, Daegu (KR); Hyo Su KIM, Daegu (KR); Jae Wook KIM, Cheongju-si, Chungcheongbuk-do (KR)

(73) Assignee: JINHEUNGTECH CO., LTD., Daegu (KR)

(21) Appl. No.: 16/338,556

(22) PCT Filed: Nov. 24, 2016
(86) PCT No.: PCT/KR2016/013637

§ 371 Date: Apr. 1, 2019

(30) Foreign Application Priority Data
Oct. 7, 2016 (KR) 10-2016-0129528

(51) Int. Cl. H02J 7/00; B64C 39/02

(52) U.S. Cl. CPC H02J 7/0027; B64C 2201/042; B64C 39/024

(57) ABSTRACT

Disclosed are an unmanned aerial vehicle and an automatic charging device for the aerial vehicle. The aerial vehicle includes a main body comprising a battery and a flying power providing unit driven by power supplied from the battery to generate flying power; and a connecting portion comprising a first charging terminal and a second charging terminal disposed in the main body and electrically connected to different polarities, respectively of the battery. The charging device includes a charging platform in which the aerial vehicle is seated; a first electrode and a second electrode spaced apart from each other in the charging platform; and a power supply unit electrically connected to the first electrode and the second electrode.

### BACKGROUND OF THE INVENTION

### Field of the Invention

The present invention relates to an unmanned aerial vehicle and an unmanned aerial vehicle automatic charging device, and more particularly, to an unmanned aerial vehicle and an unmanned aerial vehicle automatic charging device capable of charging a battery of the unmanned aerial vehicle in a self-aligning manner through coupling between a connecting portion mounted in the unmanned aerial vehicle and a recessed portion formed in the unmanned aerial vehicle automatic charging device.

### Related Art

Unmanned aerial vehicles are referred to as drones or UAEs and indicate flight vehicles flying by autonomous flight without a person on board or maneuvering remotely. Because a person does not board the unmanned aerial vehicle (hereinafter, UAV), a space for a person on board and a safety device for safety of the person on board are not required and thus the UAV may be formed in a small size and a light weight. In the UAV, because it is not required that the person boards, the UAV is much used for reconnaissance and information gathering in dangerous areas in which a manned aircraft could not be accessed for safety of passengers.

For example, currently, UAVs are playing a role of obtaining aerial images of disaster areas such as radiation exposure areas and fire occurrence areas, which are difficult to reach by the manned aircraft.

UAVs may be classified into a battery type and an engine type according to a method of providing flying power. Compared with engine type UAVs, because battery type UAVs have advantages in an aspect of a small size and light weight, the battery type UAVs have recently been much used in fields such as fire monitoring, aerial photography, and cargo transportation. However, in the case of a battery type UAV, especially a propeller type UAV capable of performing vertical takeoff and landing, it is necessary to rotate a number of propellers in order to obtain flying power. In this process, because a battery consumption amount increases, there is a problem that the battery should be continuously replaced.

Though there may be some differences according to a battery capacity, when driving an UAV using a disposable battery, a time available for flying is about 10 minutes. Therefore, in the case of forest monitoring requiring image capturing of a wide area and disaster area aerial photographing requiring image capturing for a long time, a short flight time of UAVs is an obstructive factor of UAV use.

The present specification proposes technology that can use a battery type UAV for a long time. Conventional technologies for increasing a flight time of UAVs include Korean Registered Patent No. 10-1599423 entitled “Drone recharging platform system” and Korean Unexamined Patent Application No. 10-2012-0133885 entitled “Small aerial unmanned robot operation system”.

### SUMMARY OF THE INVENTION

The present invention has been made to solve the above problems and provides technology that can effectively increase a short flight time of an UAV through battery charging of the UAV through an UAV having a connecting portion and an automatic charging device having a recessed portion coupled to the connecting portion disclosed in the present specification.

In an embodiment, an UAV is disclosed. The UAV includes a main body and a connecting portion. The main body includes a battery and a flying power providing unit driven by power provided from the battery to generate flying power. The connecting portion includes a first charging terminal and a second charging terminal disposed in the main body and electrically connected to different polarities, respectively of the battery. The first charging terminal and the second charging terminal are disposed apart from each other at an outer surface of the connecting portion. In this case, in a process in which the main body is seated in the charging platform, at least a portion (hereinafter, referred to as an insertion portion) of the connecting portion is inserted into a recessed portion formed in the charging platform. In a process in which the insertion portion is inserted into the recessed portion, the first charging terminal and the second charging terminal are electrically connected to a first electrode and a second electrode, respectively spaced apart from each other in the charging platform. The first charging terminal and the second charging terminal are electrically connected to the first electrode and the second electrode, respectively and thus the battery may receive electric energy from the charging platform to be charged.

In another embodiment, an UAV automatic charging device for charging an UAV is disclosed.

The UAV includes a main body and a connecting portion. The main body includes a battery and a flying power providing unit driven by power provided from the battery to generate flying power. The connecting portion includes a first charging terminal and a second charging terminal disposed in the main body and electrically connected to different polarities, respectively of the battery. The first charging terminal and the second charging terminal are disposed apart from each other at an outer surface of the connecting portion.

The automatic charging device includes a charging platform in which the UAV may be seated, a first electrode and second electrode spaced apart from each other in the charging platform, and a power supply unit capable of being electrically connected to the first electrode and the second electrode. The charging platform includes a seating portion having a shape in which the UAV may be seated and in which at least one recessed portion is formed and having at least one recessed portion into which at least a portion (hereinafter, referred to as an insertion portion) of the connecting portion may be inserted. The first electrode and the second electrode are disposed apart from each other in any one selected from a surface of the recessed portion, a surface of the seating portion adjacent to the recessed portion, and combinations thereof. In this case, in a process in which the insertion portion is inserted into the recessed portion, the first charging terminal and the second charging terminal are electrically connected to the first electrode and the second electrode, respectively. The first charging terminal and the second charging terminal are electrically connected to the first electrode and the second electrode, respectively and thus the battery may receive electric energy from the power supply unit to be charged.

### Advantageous Effects

An UAV disclosed in the present specification includes a connecting portion and thus in a process in which the UAV is seated in a charging platform, a battery can be automatically charged through a process in which the connecting portion, i.e., an insertion portion is inserted into a recessed portion of the charging platform. The UAV disclosed in the present specification can provide the effect of charging the battery through an AC charging method as well as DC charging through the above-described method.

In an UAV automatic charging device disclosed in the present specification, a first charging terminal and a second charging terminal of the UAV are self-aligned with a first electrode and a second electrode, respectively, of the automatic charging device to be electrically connected to each other through coupling between a connecting portion mounted in the UAV and a recessed portion formed in the UAV automatic charging device. Thereby, a separate additional process to match the polarity of the charging terminal of the UAV and the polarity of the automatic charging device is not required, thereby minimizing a time loss in a process of disposing the UAV in the automatic charging device.

Further, each unit battery constituting a battery mounted in the unmanned air vehicle disclosed in the present specification may be electrically connected to the first charging terminal and the second charging terminal through the connecting portion. The first charging terminal and the second charging terminal may be electrically connected to the first electrode and the second electrode, respectively of the automatic charging device. Thereby, each unit battery can be individually charged, thereby effectively reducing a charging time of the battery.

Further, the UAV automatic charging device disclosed in the present specification may include a solar cell panel. Thereby, even before or while charging the UAV, it is possible to generate electricity using solar light. After being stored, photovoltaic electric energy can be used for charging the UAV or can be used as a driving energy source of electronic devices such as a camera mounted in a communication pillar in which the UAV automatic charging device is disposed.

Further, the UAV automatic charging device disclosed in the present specification may include a weight sensor or a contact detection sensor. Thereby, because it is possible to detect whether the UAV is seated, only when the UAV is seated, electric energy can be supplied to the first electrode and the second electrode through a power supply unit. Only when the UAV is seated, because power is supplied, consumption of standby power can be prevented. Further, a function of preventing a malfunction of the automatic charging device due to natural objects such as birds or branches and obstacles can be provided.

The foregoing description provides only a selective concept in a simplified form of a description to be described in more detail hereinafter. The present description is not provided to limit major features or essential features of the claims or to limit the scope of the claims.

### BRIEF DESCRIPTION OF THE DRAWINGS

FIG. 1 is a diagram illustrating a use example of an UAV and an UAV automatic charging device disclosed in the present specification.

FIGS. 2 and 3 are conceptual diagrams illustrating an UAV and an UAV automatic charging device disclosed in the present specification.

FIGS. 4 to 9 are diagrams illustrating various embodiments for explaining a process of charging a battery of a UAV through coupling between a connecting portion of the UAV and a recessed portion of the UAV automatic charging device disclosed in the present specification.

FIG. 10 is a diagram illustrating a communication process between the UAV and the UAV automatic charging device disclosed in the present specification.

FIG. 11 is a simulation diagram for helping understanding of the UAV and the UAV automatic charging device disclosed in the present specification.

### DESCRIPTION OF EXEMPLARY EMBODIMENTS

Hereinafter, embodiments disclosed in the present specification will be described in detail with reference to the drawings. Like reference numerals in the drawings denote like elements, unless the context clearly indicates otherwise. The exemplary embodiments described in the detailed description, the drawings, and the claims are not intended to limit, and other embodiments may be used, and other variations are available without departing from the spirit or scope of the disclosed technology. Those skilled in the art will appreciate that the components of the present disclosure, i.e., the components generally described herein and illustrated in the figures, may be arranged, configured, combined, or designed in various different configurations, all of which are expressly contemplated, and it will be readily understood that the invention forms part of the disclosure. In the drawings, in order to clearly represent various layers (or films), regions and shapes, the width, length, thickness, or shape of an element may be exaggerated.

When a component is referred to as being “disposed” in another component, it may include a case where an additional component is interposed therebetween as well as a case where the component is directly disposed at the other component.

When a component is referred to as being “connected” to another component, it may include a case where an additional component is interposed therebetween as well as a case where the component is directly connected to the other component.

When a component is referred to as being “seated” in another component, it may include a case where an additional component is interposed therebetween as well as a case where the component is directly seated in the other component.

A description of the disclosed technology is merely an example for a structural or functional description and thus the scope of the disclosed technology should not be construed as being limited by the embodiments described in the text. That is, because an embodiment may be variously changed and have several forms, it should be understood that the scope of the present invention includes equivalents that can realize the spirit thereof.

Singular forms used here include a plurality of forms unless phrases explicitly represent an opposite meaning, and a term of “comprising” or “having” used in a specification embodies presence of a characteristic, number, step, operation, element, component, or combinations thereof and does not exclude presence or addition of one or more characteristic, number, step, operation, element, component, or combinations thereof.

Unless differently defined, all terms used here have the same meaning as a meaning that may be generally understood by a person of common skill in the art. It should be analyzed that terms defined in a generally using dictionary have a meaning corresponding with that of a context of related technology and are not analyzed as an ideal or excessively formal meaning unless explicitly defined in the present invention.

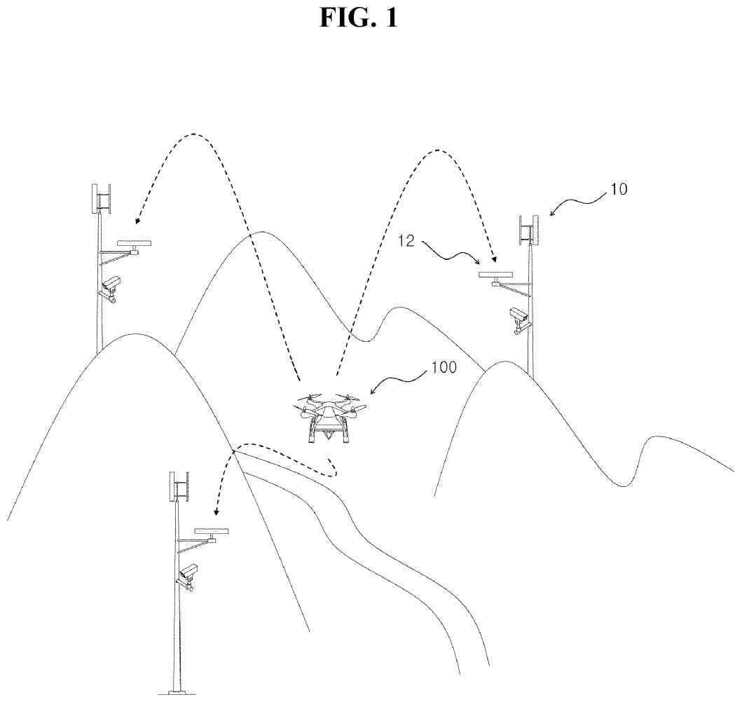

FIG. 1 is a diagram illustrating a use example of an UAV and an UAV automatic charging device disclosed in the present specification.

An UAV 100 is driven by a battery. Therefore, when the battery is discharged, the UAV 100 may no longer fly. When an operator of the UAV 100 is in the vicinity of an active area of the UAV 100, the operator may fully use the battery and then recover the UAV 100 immediately before the battery is discharged and charge or replace the battery and thus a serious problem does not occur in battery use of the UAV 100. However, when the operator operates the UAV 100 at a remote place, if the battery is sufficiently used, a problem of a loss of the UAV 100 according to discharge of the battery or a damage of the UAV 100 according to fall of the UAV 100 may occur. In order to prevent this, when aerial image photographing is performed using the UAV 100 at a remote place, a battery capacity requiring for recovering the UAV 100 should be left. Therefore, in order to operate the UAV 100 at a remote place, there is a problem that should increase a battery capacity or reduce a flight time.

Technology disclosed in the present specification is technology derived to solve this problem. As illustrated in FIG. 1, transmission towers, communication towers, and forest fire detection camera facilities (hereinafter, referred to as communication pillars) are scattered all over the country. After an UAV automatic charging device support 12 is installed in a communication pillar 10, an UAV automatic charging device 200 disclosed in the present specification may be disposed in the UAV automatic charging device support 12. The operator may take an aviation image by manipulating the UAV 100 at a remote place, and when the battery of the UAV 100 is discharged in this process, by charging the battery by seating the UAV 100 in the near UAV automatic charging device 200, the operator may take an aerial image for a long time without recovering the UAV 100. In this case, the power supply unit 230 and a controller 250 may be installed in the communication pillar 10. Because the power supply unit 230 uses a power source already installed in the communication pillar 10, a facility investment cost can be reduced.

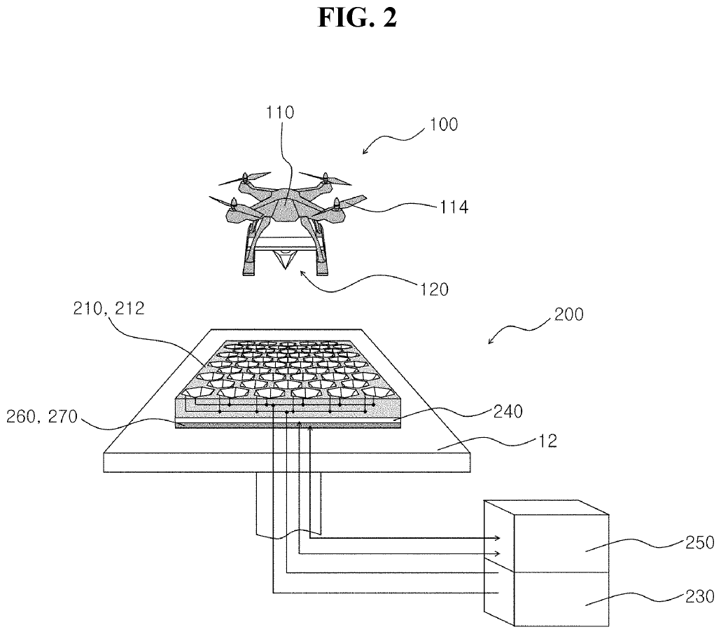

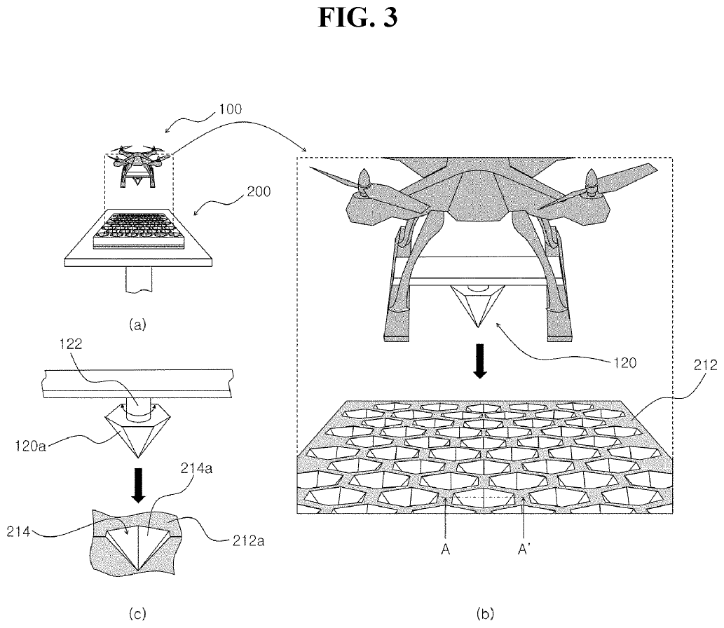

FIGS. 2 and 3 are conceptual diagrams illustrating an UAV and an UAV automatic charging device disclosed in the present specification. FIG. 2 is a conceptual diagram of the UAV 100 and the UAV automatic charging device 200. FIG. 3(a) is a diagram illustrating the UAV 100 to be seated in the UAV automatic charging device 200. FIG. 3(b) is a partially enlarged view of FIG. 3(a) and FIG. 3(c) is a cross-sectional view of a seating portion 212 taken along a line AA′ and is a diagram illustrating a connecting portion rotating shaft 122 and an insertion portion 120a of the UAV 100.

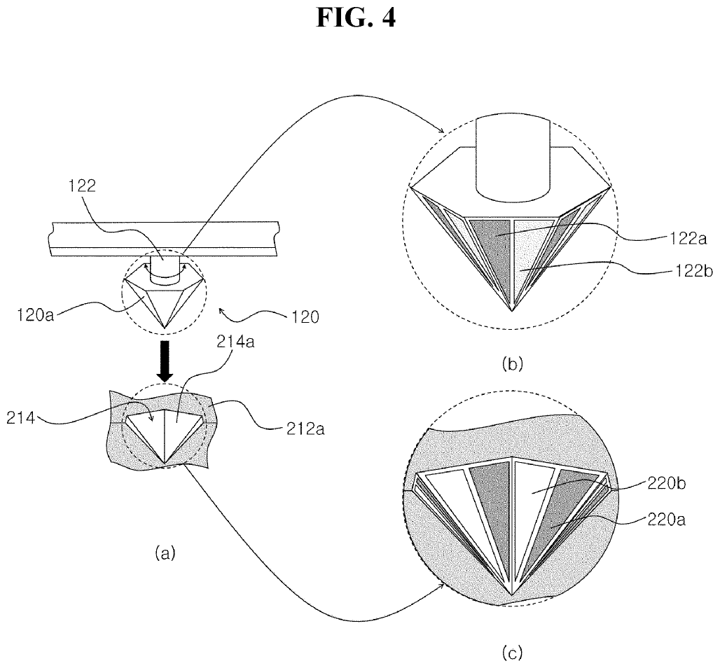

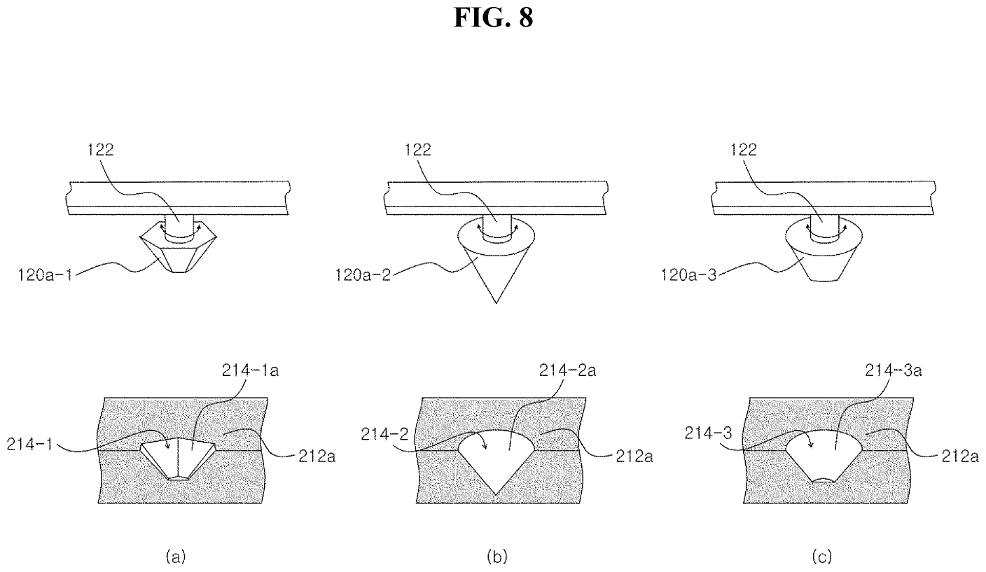

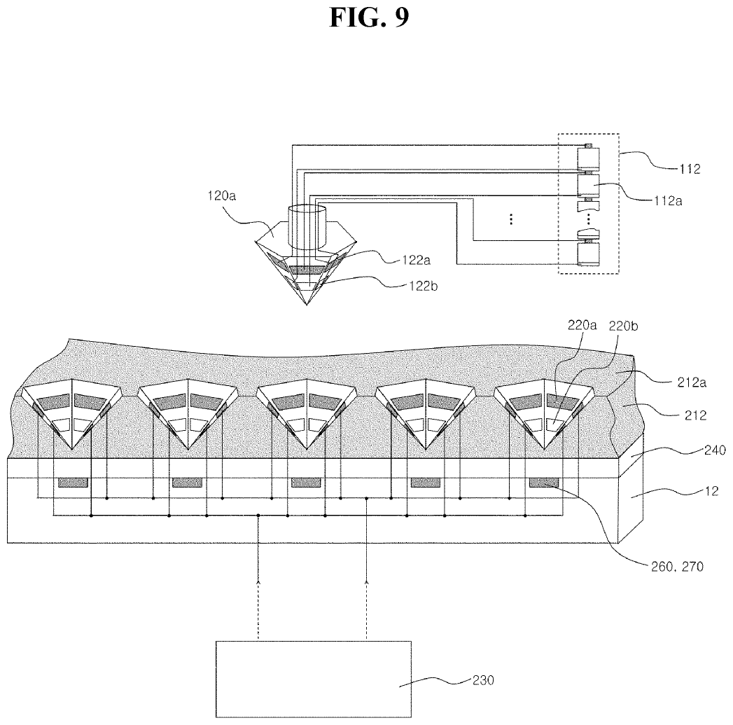

FIGS. 4 to 9 are diagrams illustrating various embodiments for explaining a process of charging a battery of a UAV through coupling between a connecting portion of the UAV and a recessed portion of the UAV automatic charging device disclosed in the present specification. In each drawing of FIGS. 4 to 7, (a) shows a coupling process of a connecting portion and a recessed portion, (b) shows a disposition shape of a first charging terminal and a second charging terminal, and (c) shows a disposition shape of a first electrode and a second electrode. FIGS. 8(a) to 8(c) are diagrams showing various shapes of the connecting portion and the recessed portion. FIG. 9 is a diagram illustrating a charging process of the battery of the UAV 100.

Hereinafter, the UAV 100 and the UAV automatic charging device 200 disclosed in the present specification will be described with reference to the drawings.

First, the UAV 100 will be described. Referring to the drawings, the UAV 100 includes a main body 110 and connecting portions 120 and 120′.

The main body 110 includes a battery 112 and a flying power providing unit 114 driven by power provided from the battery 112 to generate flying power. The battery 112 may be configured with connection of a plurality of unit batteries 112a, as illustrated in FIG. 9. The flying power providing unit 114 may be configured with a plurality of propellers, as illustrated in FIGS. 1 to 3.

The connecting portions 120 and 120′ include a first charging terminal 122a and a second charging terminal 122b disposed in the main body 110 and electrically connected to different polarities, respectively, of the battery 112. In the drawing, the connecting portions 120 and 120′ disposed at a plate-shaped frame connected to takeoff and landing support legs of the UAV 100 are illustrated, but when the connecting portions 120 and 120′ may be disposed at the main body 110 to perform a function to be described later, a disposition form thereof is not limited. The first charging terminal 122a and the second charging terminal 122b are disposed apart from each other at outer surfaces of the connecting portions 120 and 120′.

In this case, as illustrated in FIGS. 3 to 9, in a process in which the main body 110 is seated in a charging platform 210, at least a portion (hereinafter, referred to as insertion portions 120a, 120a-1, 120a-2, and 120a-3) of the connecting portions 120 and 120′ is inserted into recessed portions 241, 214-1, 214-2, and 214-3 formed in the charging platform 210. In a process in which the insertion portions 120a, 120a-1, 120a-2, and 120a-3 are inserted into the recessed portions 214, 214-1, 214-2, and 214-3, the first charging terminal 122a and the second charging terminal 122b are electrically connected to a first electrode 220a and a second electrode 220b spaced apart from each other in the charging platform 210. The first charging terminal 122a and the second charging terminal 122b are electrically connected to the first electrode 220a and the second electrode 220b, respectively and thus the battery 112 may receive electric energy from the charging platform 210 to be charged.

As illustrated in FIGS. 3 to 9, the insertion portions 120a, 120a-1, 120a-2, and 120a-3 may have a shape of at least one selected from a cone, a truncated cone, a pyramid, a prismoid, and combinations thereof formed to face a direction of gravity. As illustrated in FIGS. 3 to 9, the recessed portions 214, 214-1, 214-2, and 214-3 may have a recessed shape corresponding to the insertion portions 120a, 120a-1, 120a-2, and 120a-3. Because the insertion portions 120a, 120a-1, 120a-2, and 120a-3 and the recessed portions 214, 214-1, 214-2, and 214-3 have shapes corresponding to each other, in a process in which the insertion portions 120a, 120a-1, 120a-2, and 120a-3 are inserted into the recessed portions 214, 214-1, 214-2, and 214-3, the insertion portions 120a, 120a-1, 120a-2, and 120a-3 are inserted to engage with the recessed portions 214, 214-1, 214-2, and 214-3 and thus the first charging terminal 122a and the second charging terminal 122b may be self-aligned with the first electrode 220a and the second electrode 220b, respectively to be electrically connected to each other. Thereby, the UAV 100 disclosed in the present specification includes connecting portions 120 and 120′ and thus in a process in which the UAV 100 is seated in the charging platform 210, the battery 112 may be automatically charged through a process in which the connecting portions 120 and 120′, i.e., the insertion portions 120a, 120a-1, 120a-2, and 120a-3 are inserted into the recessed portions 214, 214-1, 214-2, and 214-3 of the charging platform 210. The UAV 100 disclosed in the present specification may provide the effect that the battery 112 may be charged through an AC charging method as well as DC charging through the above-described method. A detailed description thereof will be described in a detailed description of the UAV automatic charging device 200 to be described later for convenience of description.

Next, the UAV automatic charging device 200 for charging the unmanned air vehicle 100 will be described.

Referring to the drawings, the UAV 100 includes a main body 110 and connecting portions 120 and 120′, as described above.

The main body 110 includes a battery 112 and a flying power providing unit 114 driven by power provided from the battery 112 to generate flying power. The battery 112 may be configured with connection of a plurality of unit batteries 112a, as illustrated in FIG. 9. The battery 112 may be disposed inside the main body 110 or may be attached to the outside of the main body 110. As illustrated in FIG. 9, a positive electrode and a negative electrode of the unit battery 112a may be electrically connected to the first charging terminal 122a and the second charging terminal 122b, respectively through a conductive material such as a wire. The first charging terminal 122a and the second charging terminal 122b may be electrically connected to the first electrode 220a and the second electrode 220b, respectively through a process to be described later. Because the first electrode 220a and the second electrode 220b may be electrically connected to the power supply unit 230, the unit batteries 112a each may be charged through the first charging terminal 122a and the second charging terminal 122b. Thereby, the UAV 100 disclosed in the present specification may be charged through the UAV automatic charging device 200. FIG. 9 illustrates a charging method in which the battery 112 receives DC power supplied from the power supply unit 230 through the first charging terminal 122a and the second charging terminal 122b to be charged as a charging method of the battery 112. In another example, the battery 112 may receive AC power from the power supply unit 230 to be charged. In this case, a rectifier (not shown) may be disposed among the first charging terminal 122a and the second charging terminal 122b and the battery 112.

Further, FIG. 9 illustrates a case of charging each of the unit batteries 112a as a charging method of the battery 112. In another example, the battery 112 may electrically connect a positive electrode and a negative electrode located at both ends of the unit batteries 112a connected in series to each other to the first charging terminal 122a and the second charging terminal 122b, respectively through a conductive material such as a lead wire to be charged. From a viewpoint of shortening a charging time, it may be preferable to charge each of the unit batteries 112a, as shown in FIG. 9.

The flying power providing unit 114 may be configured with a plurality of propellers, as illustrated in FIGS. 1 to 3.

The connecting portions 120 and 120′ include a first charging terminal 122a and a second charging terminal 122b disposed in the main body 110 and electrically connected to different polarities, respectively, of the battery 112. In the drawing, the connecting portions 120 and 120′ disposed at a plate-shaped frame connected to takeoff and landing support legs of the UAV 100 are illustrated, but when the connecting portions 120 and 120′ may be disposed in the main body 110 to perform a function to be described later, a disposition form of the connecting portions 120 and 120′ is not limited. The first charging terminal 122a and the second charging terminal 122b are disposed apart from each other at outer surfaces of the connecting portions 120 and 120′.

The UAV automatic charging device 200 includes a charging platform 210, a first electrode 220a and second electrode 220b, and a power supply unit 230. In some other embodiments, the UAV automatic charging device 200 may further optionally include a solar cell panel 240. In some further embodiments, the UAV automatic charging device 200 may further optionally include a controller 250 and a weight sensor 260. In some further embodiments, the UAV automatic charging device 200 may further optionally include a controller 250 and a plurality of contact detection sensors 270.

The UAV 100 may be seated in the charging platform 210.

The first electrode 220a and the second electrode 220b are disposed apart from each other in the charging platform 210.

The power supply unit 230 may be electrically connected to the first electrode 220a and the second electrode 220b.

As illustrated in FIGS. 2-9, the charging platform 210 includes a seating portion 212 having a shape in which the UAV 100 may be seated and having at least one recessed portion 214, 214-1, 214-2, and 214-3 in which at least a portion (hereinafter, insertion portions 120a, 120a-1, 120a-3, and 120a-3) of the connections 120 and 120′ may be inserted.

As illustrated in FIGS. 4 to 9, the first electrode 220a and the second electrode 220b are disposed apart from any one selected from surfaces 214a, 214-1a, 214-2a, and 214-3a of the recessed portions 214, 214-1, 214-2, and 214-3, a surface 212a of the seating portion adjacent to the recessed portions 214, 214-1, 214-2, and 214-3, and combinations thereof.

In this case, in a process in which the insertion portions 120a, 120a-1, 120a-2, and 120a-3 are inserted into the recessed portions 214, 214-1, 214-2, and 214-3, the first charging terminal 122a and the second charging terminal 122b are electrically connected to the first electrode 220a and the second electrode 220b, respectively. The first charging terminal 122a and the second charging terminal 122b are electrically connected to the first electrode 220a and the second electrode 220b, respectively and thus the battery 112 may receive electric energy from the power supply unit 230 to be charged.

As illustrated in FIGS. 3 to 9, the insertion portions 120a, 120a-1, 120a-2, and 120a-3 may have a shape of at least one selected from a cone, a truncated cone, a pyramid, a prismoid, and combinations thereof formed to face a direction of gravity. As illustrated in FIGS. 3 to 9, the recessed portions 214, 214-1, 214-2, and 214-3 may have a recessed shape corresponding to the insertion portions 120a, 120a-1, 120a-2, and 120a-3. Because the insertion portions 120a, 120a-1, 120a-2, and 120a-3 and the recessed portions 214, 214-1, 214-2 and 214-3 have mutual corresponding shapes, in a process in which the insertion portions 120a, 120a-1, 120a-2, and 120a-3 are inserted into the recessed portions 214, 214-1, 214-2, and 214-3, the insertion portions 120a, 120a-1, 120a-2, and 120a-3 are inserted to engage with the recessed portions 214, 214-1, 214-2, and 214-3 and thus the first charging terminal 122a and the second charging terminal 122b are self-aligned with the first electrode 220a and the second electrode 220b, respectively to be electrically connected to each other. Thereby, the UAV 100 disclosed in the present specification includes connecting portions 120 and 120′ and thus in a process in which the UAV 100 is seated in the charging platform 210, the battery 112 may be automatically charged through a process in which the connecting portions 120 and 120′, i.e., the insertion portions 120a, 120a-1, 120a-2, and 120a-3 are inserted into the recessed portions 214, 214-1, 214-2, and 214-3 of the charging platform 210. The UAV 100 disclosed in the present specification may provide the effect that the battery 112 may be charged through an AC charging method as well as DC charging through the above-described method.

Hereinafter, a process in which the first charging terminal 122a and the second charging terminal 122b are electrically connected to the first electrode 220a and the second electrode 220b, respectively and in which the battery 112 thus receives electric energy from the power supply unit 230 to be charged will be described with reference to FIGS. 4 to 9.

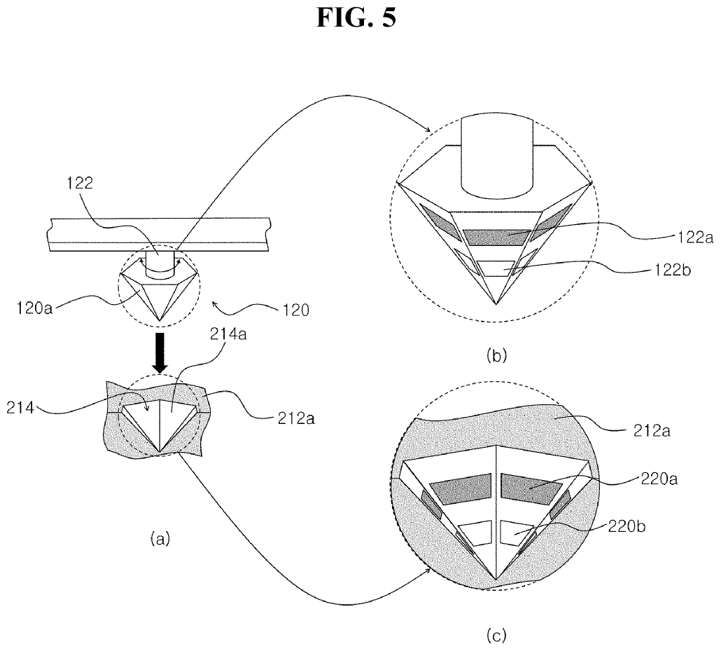

In an embodiment, the insertion portion 120a may have a shape of a pyramid or a prismoid having the n (n is a natural number of 3 or more) number of side surfaces formed to face a direction of gravity. The prismoid-shaped insertion portion 120a-1 is illustrated in FIG. 8(a). It should be understood that the prismoid disclosed in the present specification includes a case of a shape in which a bottom surface and a top surface are not parallel to each other as well as a case of a shape in which a bottom surface and a top surface are parallel to each other. Further, it should be understood that the pyramid disclosed in the present specification includes a pyramid shape formed on a truncated cone or a prismoid as well as a single pyramid. In each drawing of FIGS. 4 and 5, an insertion portion 120a having a hexagonal pyramid shape is illustrated. The recessed portion 214 may have a recessed shape corresponding to the insertion portion 120a. In at least one side surface (hereinafter, referred to as a charging terminal disposition surface) of the n number of side surfaces of the insertion portion 120a, the first charging terminal 122a and the second charging terminal 122b may be disposed apart from each other. FIG. 4 illustrates a case in which all six side surfaces of the hexagonal pyramid-shaped insertion portion 120a serve as a charging terminal disposition surface. Further, FIG. 4 illustrates the first charging terminal 122a and the second charging terminal 122b spaced apart from each other while facing each other based on a direction of gravity at the charging terminal disposition surface. Alternatively, as illustrated in FIG. 5, the first charging terminal 122a and the second charging terminal 122b may be disposed in a form apart from each other at a predetermined distance based on a direction of gravity at the charging terminal disposition surface.

In at least one inner circumferential surface (hereinafter, referred to as an electrode disposition surface) of inner circumferential surfaces opposite to the charging terminal disposition surface among the n number of inner peripheral surfaces of the recessed portion 214 into which the insertion portion 120a is inserted, the first electrode 220a and the second electrode 220b may be disposed apart from each other to be opposite to the first charging terminal 122a and the second charging terminal 122b, respectively. Each drawing of FIGS. 4 and 5 illustrates six inner circumferential surfaces of the recessed portion 214, i.e., the first electrode 220a and the second electrode 220b disposed at a surface 214a of the recessed portion 214 to be opposite to the first charging terminal 122a and the second charging terminal 122b disposed at all six side surfaces of the hexagonal pyramid-shaped insertion portion 120a. In this case, in a process in which the insertion portion 120a is inserted into the recessed portion 214, the first charging terminal 122a and the second charging terminal 122b disposed at the charging terminal disposition surface are electrically connected to the first electrode 220a and the second electrode 220b, respectively disposed at the electrode disposition surface and thus the battery 112 may receive electric energy from the power supply unit 230 to be charged.

Each drawing of FIGS. 4 and 5 illustrates a pair of first charging terminal 122a and second charging terminal 122b spaced apart from each other at the charging terminal disposition surface. Further, each drawing of FIGS. 4 and 5 illustrates a pair of first electrode 220a and second electrode 220b spaced apart from each other at the electrode disposition surface. Because the insertion portion 120a and the recessed portion 214 have shapes corresponding to each other, in a process in which the insertion portion 120a is inserted into the recessed portion 214, the first charging terminal 122a and the second charging terminal 122b are naturally electrically connected to the first electrode 220a and the second electrode 220b, respectively. Thereby, the battery 112 may receive electric energy from the power supply unit 230 to be charged.

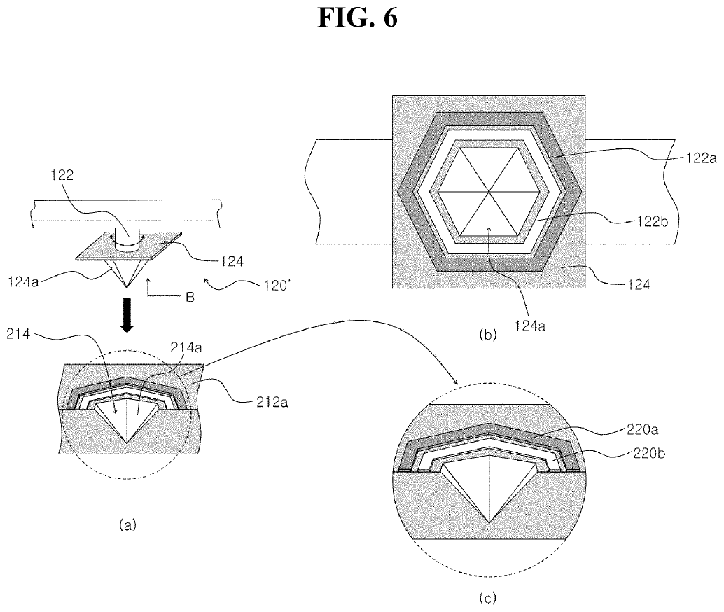

Further, FIGS. 4 and 5 illustrate the first charging terminal 122a and the second charging terminal 122b and the first electrode 220a and the second electrode 220b spaced apart from each other. Alternatively, unlike FIGS. 4 and 5, when power supplied from the power supply unit 230 to each of the first electrodes 220a and each of the second electrodes 220b is the same, the first charging terminals 122a, the second charging terminals 122b, the first electrodes 220a, and the second electrodes 220b may be connected to each other in groups, as in the first charging terminal 122a and the second charging terminal 122b and the first electrodes 220a and the second electrodes 220b connected to each other, as illustrated in FIG. 6.

When only a side surface of some of the insertion portions 120a performs a function of the charging terminal disposition surface and when only some surfaces of the recessed portion 214 perform a function as the electrode disposition surface, in a process in which the insertion portion 120a is inserted into the recessed portion 214, it is necessary to face the insertion portion 120a and the recessed portion 214 to each other. In this case, by driving the connecting portion rotating shaft 122 with a rotation method, the insertion portion 120a and the recessed portion 214 may face each other. It may be preferable that all side surfaces of the insertion portion 120a perform a function of the charging terminal disposition surface and that all surfaces of the recessed portion 214 perform a function of the electrode disposition surface. In this case, by rotating the connecting portion rotating shaft 122, a process of facing the charging terminal disposition surface and the electrode disposition surface to each other may be omitted.

In a process in which the insertion portion 120a is inserted into the recessed portion 214, the insertion portion 120a may be latched to the surface 212a of the seating portion or an edge of the recessed portion 214. In this case, by driving the connecting portion rotating shaft 122 with a rotation method or a vibration method, the insertion portion 120a may be inserted into the recessed portion 214.

In another embodiment, the insertion portion 120a may have a shape of a cone or a truncated cone formed to face a direction of gravity. The cone-shaped insertion portion 120a-2 and the truncated cone-shaped insertion portion 120a-3 are illustrated in FIGS. 8(b) and 8(c). It should be understood that the truncated cone disclosed in the present specification includes a case of a shape in which a bottom surface and a top surface are not parallel to each other as well as a case of a shape in which a bottom surface and a top surface are parallel to each other. Further, it should be understood that the cone disclosed in the present specification includes a conical shape formed on a truncated cone or prismoid as well as a single cone. Further, it should be understood that the cone or the truncated cone disclosed in the present specification includes a case in which a cross section is an ellipse as well as a case in which a cross section is a circle. The recessed portion 214 may have a recessed shape corresponding to the insertion portion 120a. FIGS. 8(b) and 8(c) illustrate recessed portions 214-2 and recessed portions 214-3 having recessed shapes corresponding to the insertion portions 120a-2 and 120a-3, respectively.

In a detailed description described with reference to FIGS. 4 and 5, except that the recessed portion 214 and the insertion portion 120a have a cone (or truncated cone) shape and a shape corresponding to the cone (or truncated cone) shape, the first charging terminal 122a and the second charging terminal 122b are electrically connected to the first electrode 220a and the second electrode 220b, respectively, with a method substantially the same as the above-described method and thus a process may be described in which the battery 112 receives electric energy from the power supply unit 230 to be charged and the process will be thus described with reference to FIGS. 4, 5, and 8. Further, substantially the same description as the above-described description or a description that may infer from the above-described description will be omitted for convenience of description in relation to FIGS. 4, 5, and 8. It is clear that such a description is not intended to limit the scope of protection of the invention disclosed in the present embodiment.

The first charging terminal 122a and the second charging terminal 122b may be disposed apart from each other based on a direction of gravity at outer surfaces, i.e., side surfaces of the insertion portions 120a-2 and 120a-3. The first electrode 220a and the second electrode 220b may be disposed apart from each other to face the first charging terminal 122a and the second charging terminal 122b at inner circumferential surfaces of the recessed portions 214-2 and 214-3. In a process in which the insertion portions 120a-2 and 120a-3 are inserted into the recessed portions 214-2 and 214-3, the first charging terminal 122a and the second charging terminal 122b disposed at the side surfaces of the insertion portions 120a-2 and 120a-3 are electrically connected to the first electrode 220a and the second electrode 220b disposed at surfaces of the recessed portions 214-2 and 214-3, i.e., at inner circumferential surfaces 214-2a and 214-3a of the recessed portions 214-2 and 214-3, respectively, and thus the battery 112 may receive electric energy from the power supply unit 230 to be charged.

In a process in which the insertion portions 120a-2 and 120a-3 are inserted into the recessed portions 214-2 and 214-3, the insertion portions 120a-2 and 120a-3 may be latched to the surface 212a of the seating portion. In this case, by driving the connecting portion rotating shaft 122 with a rotation or vibration method, the insertion portion 120a-2 and 120a-3 may be inserted into the recessed portions 214-2 and 214-3.

Because the insertion portion 120a and the recessed portion 214 described with reference to FIGS. 4 and 5 have a polygonal shape, in a process in which the insertion portion 120a is inserted into the recessed portion 214, the insertion portion 120a may be latched to an edge of the recessed portion 214. However, when a cross-sectional shape of the cone or truncated cone-shaped insertion portions 120a-2 and 120a-3 and recessed portions 214-2 and 214-3 disclosed in the present specification based on a direction of gravity is a circle, in a process in which the insertion portion 120a is inserted into the recessed portion 214, the insertion portion 120a may have an advantage that the insertion portion 120a is not latched to the edge of the recessed portion 214.

In another embodiment, as illustrated in FIGS. 8(a) and 8(c), the insertion portion 120a may have a shape of a truncated cone 120a-3 or a prismoid 120a-1 formed to face a direction of gravity. The recessed portion 214 may have a recessed shape corresponding to the insertion portion 120a. FIGS. 8(a) and 8(c) illustrate the recessed portion 214-1 and the recessed portion 214-3 having recessed shapes corresponding to the insertion portions 120a-1 and 120a-3, respectively.

Substantially the same description as the above-described description or a description that may infer from the above-described description in relation to FIGS. 4 and 5 will be omitted for convenience of description. It is clear that such a description is not intended to limit the scope of protection of the invention disclosed in the present embodiment. Hereinafter, the first charging terminal 122a and the second charging terminal 122b are electrically connected to the first electrode 220a and the second electrode 220b, respectively and thus a process in which the battery 112 receives electric energy from the power supply unit 230 to be charged will be described with reference to FIGS. 4, 5, and 8.

The first charging terminal 122a and the second charging terminal 122b may be disposed apart from each other at outer surfaces, i.e., side surfaces of the insertion portions 120a-1 and 120a-3 and the bottom surfaces of the insertion portions 120a-1 and 120a-3. The first electrode 220a and the second electrode 220b may be disposed apart from each other to face the first charging terminal 122a and the second charging terminal 122b at inner peripheral surfaces of the recessed portions 214-1 and 214-3 and the bottom surfaces of the recessed portions 214-1 and 214-3. In a process in which the insertion portions 120a-1 and 120a-3 are inserted into the recessed portions 214-1 and 214-3, the first charging terminal 122a and the second charging terminal 122b disposed at the side surfaces of the insertion portions 120a-1 and 120a-3 and the bottom surfaces of the insertion portions 120a-1 and 120a-3 are electrically connected to the first electrode 220a and the second electrode 220b disposed at the inner circumferential surfaces of the recessed portions 214-1 and 214-3 and the bottom surface of the recessed portions 214-1 and 214-3 and thus the battery 112 may receive electric energy from the power supply unit 230 to be charged.

In another embodiment, as illustrated in FIG. 6, the connecting portion 120′ may include a support portion 124 in which a protruding portion 124a is formed. The protruding portion 124a may function as the insertion portion 120a. The recessed portion 214 may have a recessed shape corresponding to the protruding portion 124a. The protruding portion 124a has substantially the same structure and function as those of the insertion portion 120a in relation to FIGS. 4, 5, and 8, and the recessed portion 214 having a recessed portion corresponding to the protruding portion 124a has substantially the same structure and function as those of the recessed portion 214 in relation to FIGS. 4, 5 and 8 and thus a detailed description thereof will be omitted for convenience of description. It is clear that such a description is not intended to limit the scope of protection of the invention disclosed in the present embodiment.

Referring to FIG. 6, the first charging terminal 122a and the second charging terminal 122b may be disposed apart from each other at a surface of the support portion 124 having the protruding portion 124a in a shape of enclosing the protruding portion 124a. The first electrode 220a and the second electrode 220b may be disposed apart from each other to face the first charging terminal 122a and the second charging terminal 122b at the surface 212a of the seating portion adjacent to the recessed portion 214. In a process in which the protruding portion 124a is inserted into the recessed portion 214, the first charging terminal 122a and the second charging terminal 122b disposed at the surface of the support portion 124 are electrically connected to the first electrode 220a and the second electrode 220b, respectively, disposed at the surface 212a of the seating portion adjacent to the recessed portion 214 and thus the battery 112 may receive electric energy from the power supply unit 230 to be charged.

FIG. 6 illustrates a hexagonal ring-shaped first charging terminal 122a and second charging terminal 122b and a first electrode 220a and a second electrode 220b. In a process of the protruding portion 124a is inserted into the recessed portion 214, when the first charging terminal 122a, the second charging terminal 122b, the first electrode 220a, and the second electrode 220b are electrically connected to be opposite to each other, a shape of the first charging terminal 122a, the second charging terminal 122b, the first electrode 220a, and the second electrode 220b is not limited. For example, as shown in FIGS. 4 and 5, the first charging terminal 122a, the second charging terminal 122b, the first electrode 220a, and the second electrode 220b may have a shape spaced apart from each other. As illustrated in FIG. 6, when power supplied from the power supply unit 230 to each of the first electrodes 220a and each of the second electrodes 220b is the same, the first charging terminals 122a, the second charging terminals 122b, the first electrodes 220a, and the second electrodes 220b may be connected to each other in groups.

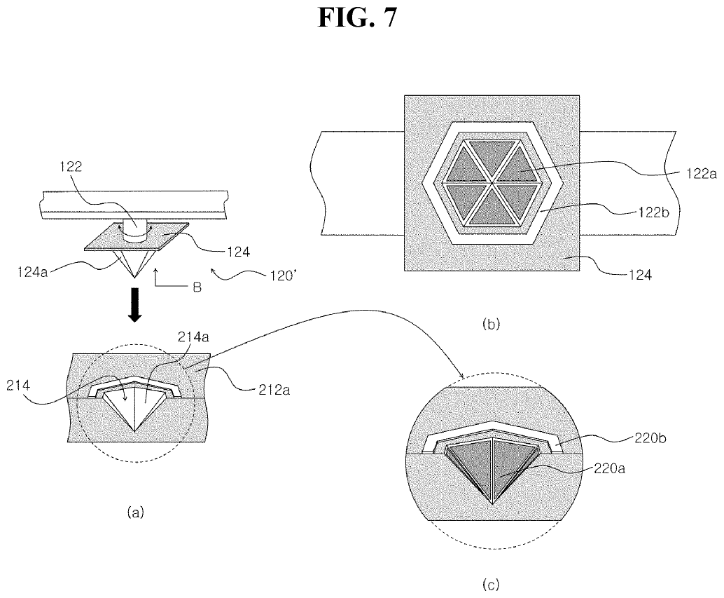

In another embodiment, as illustrated in FIG. 7, the connecting portion 120′ may include a support portion 124 in which a protruding portion 124a is formed. The protruding portion 124a may function as the insertion portion 120a. The recessed portion 214 may have a recessed shape corresponding to the protruding portion 124a. The protruding portion 124a has substantially the same structure and function as those of the insertion portion 120a in relation to FIGS. 4, 5, and 8, and the recessed portion 214 having a recessed portion corresponding to the protruding portion 124a has substantially the same structure and function as those of the recessed portion 214 in relation to FIGS. 4, 5 and 8 and thus a detailed description thereof will be omitted for convenience of description. It is clear that such a description is not intended to limit the scope of protection of the invention disclosed in the present embodiment.

Referring to FIG. 7, the first charging terminal 122a and the second charging terminal 122b may be disposed apart from each other at a surface of the protruding portion 124a and a surface of a support portion 124, respectively having the protruding portion 124a in a shape enclosing the protruding portion 124a. The first electrode 220a and the second electrode 220b may be disposed apart from each other to be opposite to the first charging terminal 122a and the second charging terminal 122b at an inner surface of the recessed portion 214 and a surface 212a of the seating portion, respectively adjacent to the recessed portion 214. In a process in which the protruding portion 124a is inserted into the recessed portion 214, the first charging terminal 122a disposed at the surface of the protruding portion 124a and the second charging terminal 122b disposed at the surface of the support portion 124 are electrically connected to the first electrode 220a disposed at the inner surface of the recessed portion 214 and the second electrode 220b, respectively, disposed at the surface 212a of the seating portion and thus the battery 112 may receive electric energy from the power supply unit 230 to be charged.

FIG. 7 illustrates the first charging terminal 122a and the hexagonal ring-shaped second charging terminal 122b spaced apart from each other in the protruding portion 124a and the second electrode 220b disposed in a hexagonal ring shape at a surface 212a of the seating portion and the first electrode 220a spaced apart from each other at the inner surface of the recessed portion 214. When the first charging terminal 122a and the second charging terminal 122b and the first electrode 220a and the second electrode 220b are opposite to each other and are electrically connected in a process of the protruding portion 124a is inserted into the recessed portion 214, a shape of the first charging terminal 122a and the second charging terminal 122b and the first electrode 220a and the second electrode 220b is not limited. For example, as shown in FIGS. 4, 5, and 6, the first charging terminal 122a, the second charging terminal 122b, the first electrode 220a, and the second electrode 220b may have a shape separated from each other or a shape connected to each other. As illustrated in FIG. 6, when power supplied from the power supply unit 230 to each of the first electrodes 220a and each of the second electrodes 220b is the same, the first charging terminals 122a, the second charging terminals 122b, the first electrodes 220a, and the second electrodes 220b may be connected to each other in groups.

As illustrated in FIGS. 2 and 9, the solar cell panel 240 may be disposed at a lower surface of the seating portion 212 based on a direction of gravity. The seating portion 212 may be made of a light-transmitting material. The solar cell panel 240 may generate solar electric energy from sunlight reaching through the seating portion 212. The generated solar electric energy may be stored by a charger (not shown), and the stored solar electric energy may be used when charging the battery 112 of the UAV 100. In order to increase an amount of sunlight reaching the solar cell panel 240, the first electrode 220a and the second electrode 220b may be made of a light-transmitting material having a light transmitting property.

The controller 250 may be electrically connected to a weight sensor 260 or a contact detection sensor 270, as illustrated in FIG. 2. The controller 250 may control an operation of the power supply unit 230. Further, the controller 250 may control an operation of the charger that stores solar electric energy generated by the solar cell panel 240. The controller 250 may be installed in the charging platform 210 or may be installed in the communication pillar 10. Alternatively, when the UAV automatic charging device 200 is installed on the ground, the controller 250 may be installed on the ground.

As illustrated in FIGS. 2 and 9, the weight sensor 260 is electrically connected to the controller 250 and is disposed at a lower surface of the seating portion 212 based on a direction of gravity to detect whether the UAV 100 is seated in the seating portion 212. In this case, when the controller 250 detects that the UAV 100 is seated in the seating portion 212 through the weight sensor 260, the controller 250 may control the power supply unit 230 to supply electric energy to the battery 112 of the UAV 100 through the first electrode 220a and the second electrode 220a. The weight sensor 260 may be disposed at an entire surface of the lower surface of the seating portion 212, but may be disposed only in a portion of the lower surface to detect whether the UAV 100 is seated.

The plurality of contact detection sensors 270 may be electrically connected to the controller 250, as illustrated in FIGS. 2 and 9. In the seating portion 212, a plurality of recessed portions 214, 214-1, 214-2, and 214-3 may be disposed apart from each other. The plurality of contact detection sensors 270 each are disposed at an inside of each of the plurality of recessed portions 214, 214-1, 214-2, and 214-3 or at a lower surface of the seating portion 212 adjacent to the inside to detect whether the insertion portions 120a, 120a-1, 120a-2, and 120a-3 are inserted into the recessed portions 214, 214-1, 214-2, and 214-3. The controller 250 may determine whether the insertion portions 120a, 120a-1, 120a-2, and 120a-3 are inserted into any one recessed portion (hereinafter, referred to as an insertion recessed portion) of the plurality of recessed portions 214, 214-1, 214-2, and 214-3 through the plurality of contact detection sensors 270 and controls the power supply unit 230 to supply electric energy to the battery 112 of the UAV 100 through the first electrode 220a and the second electrode 220b corresponding to the insertion recessed portion.

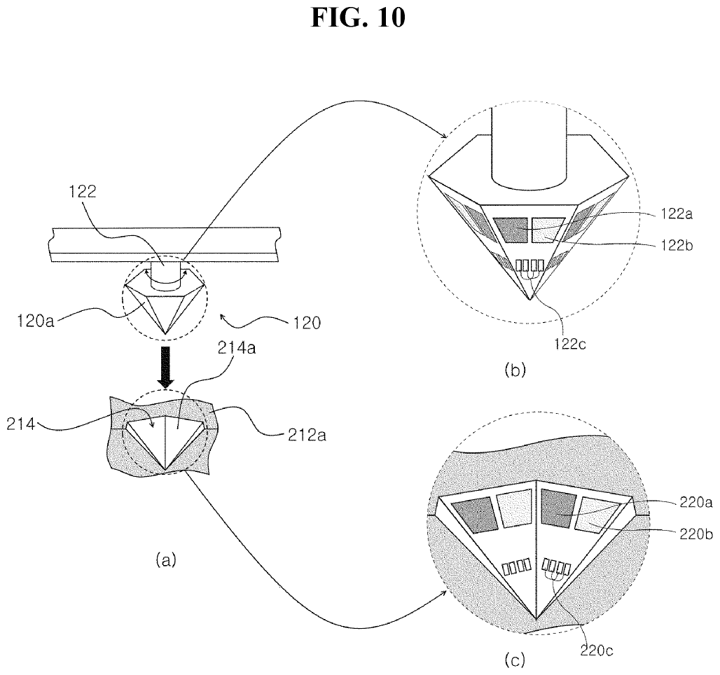

FIG. 10 is a diagram illustrating a communication process between the UAV and the UAV automatic charging device disclosed in the present specification.

Referring to FIG. 10, the connecting portion 120 may further include a first communication terminal 122c spaced apart from the first charging terminal 122a and the second charging terminal 122b at an outer surface thereof. The charging platform 210 may further include a second communication terminal 220c spaced apart from the first electrode 220a and the second electrode 220b. The UAV automatic charging device 200 may further include a controller (not shown) electrically connected to the second communication terminal 220c.

In the main body 110, an electronic device (not shown) capable of performing at least one selected from aerial image photographing, temperature detection, humidity detection, wind speed detection, position detection, and combinations thereof may be disposed. The electronic device may be, for example, a camera for photographing an aerial image, a global positioning system (GPS) sensor for providing a position of the UAV 100, and various sensors capable of detecting or measuring a temperature, humidity, and a wind speed of a position in which the UAV 100 operates.

The first communication terminal 122c may be electrically connected to the electronic device. The second communication terminal 220c may be disposed at any one selected from a surface 214a of the recessed portion 214, a surface 212a of a seating portion adjacent to the recessed portion 214, and combinations thereof.

In this case, in a process in which the insertion portion 120a is inserted into the recessed portion 214, the first communication terminal 122c and the second communication terminal 220c are electrically connected to each other and thus the controller may communicate with the electronic device. A mutual electrical connection between the first communication terminal 122c and the second communication terminal 220c may be performed in substantially the same manner as a mutual electrical connection among the first communication terminal 122c and the second communication terminal 220c and the first electrode 220a and the second electrode 220b. Those skilled in the art may sufficiently infer a mutual electrical connection between the first communication terminal 122c and the second communication terminal 220c from the mutual electrical connection among the first communication terminal 122c and the second communication terminal 220c and the first electrode 220a and the second electrode 220b and therefore, a detailed description thereof will be omitted for convenience of description.

Communication between the controller and the electronic device may be performed by a wired or wireless means. The controller may receive various data photographed, detected, or measured through the electronic device in a process in which the UAV 100 operates through communication with the electronic device. Alternatively, the controller may provide various data held by the UAV automatic charging device 200 to the electronic equipment through communication with the electronic device. The various data received by the electronic device may be provided to another UAV automatic recharging device 200 located at a predetermined distance from the UAV automatic recharging device 200 providing the data. That is, in a process in which the UAV 100 is seated in the automatic recharging device 200, the UAV 100 may provide data of the electronic device to the controller of the one UAV automatic recharging device 200 and may also be used as a data transmission means between the UAV automatic recharging devices 200. Further, the controller may perform operations such as deletion, modification, and addition of software of the electronic device through communication with the electronic device. The above example is an example for understanding, and in addition to the above example, various operations that may be performed through communication between the controller and the electronic device may be performed.

Unlike contents illustrated in the drawings, communication between the electronic device of the UAV 100 and the UAV automatic recharging device 200 may be performed through communication among the first charging terminal 122a and the second charging terminal 122b and the first electrode 220a and the second electrode 220b. In this case, the first communication terminal 122c and the second communication terminal 220c may be omitted. Communication among the first charging terminal 122a and the second charging terminal 122b and the first electrode 220a and the second electrode 220b may be performed through, for example, power line communication. In this case, the electronic device may be electrically connected to the first charging terminal 122a and the second charging terminal 122b.

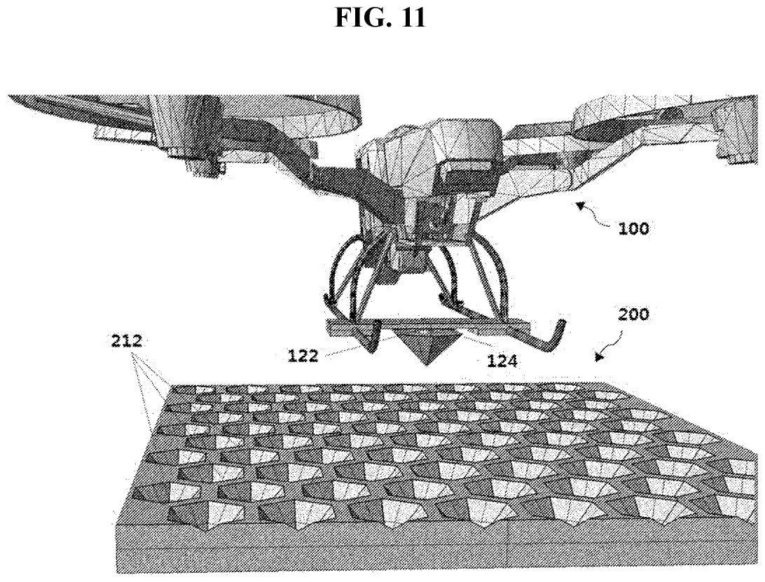

FIG. 11 is a simulation diagram for helping understanding of the UAV and the UAV automatic charging device disclosed in the present specification.

In summary, the UAV automatic charging device 200 disclosed in the present specification may enable the first charging terminal 122a and the second charging terminal 122b of the UAV 100 to be self-aligned with the first electrode 220a and the second electrode 220b, respectively of the automatic charging device 200 to be electrically connected to each other through coupling between the connecting portions 120 and 120′ mounted in the UAV 100 and the recessed portions 214, 214-1, 214-2, and 214-3 formed in the UAV automatic charging device 200. Thereby, because a separate additional process for matching the polarity of the charging terminal of the UAV 100 to the polarity of the automatic charging device 200 is not required, a time loss in a process of disposing the UAV 100 in the automatic charging device 200 can be minimized.

Further, each unit battery 112a constituting the battery 112 mounted in the UAV 100 disclosed in the present specification may be electrically connected to the first charging terminal 122a and the second charging terminal 122b through the connecting portions 120 and 120′. The first charging terminal 122a and the second charging terminal 122b may be electrically connected to the first electrode 220a and the second electrode 220b, respectively of the automatic charging device 200. Thereby, each unit battery 112a may be individually charged to effectively reduce a battery charging time.

Further, the UAV automatic charging device 200 disclosed in the present specification may include a solar cell panel 240. Thereby, it is possible to generate electricity using solar light even before or while charging the UAV 100. Photovoltaic electric energy may be stored and used for charging the UAV 100 or used as a driving energy source for electronic devices such as a camera mounted in the communication pillar 10 in which the UAV automatic charging device 200 is disposed.

Further, the UAV automatic charging device 200 disclosed in the present specification may include a weight sensor 260 or a contact detection sensor 270. The weight sensor 260 or the contact detection sensor 270 may detect whether the UAV 100 is seated and thus only when the UAV 100 is seated, electric energy may be supplied to the first electrode 220a and the second electrode 220b through the power supply unit 230. Only when the UAV 100 is seated, because power may be supplied, consumption of standby power can be prevented. Further, a function of preventing a malfunction of the automatic charging device due to natural objects such as birds or branches and obstacles can be provided.

From the foregoing description, it will be understood that various embodiments of the present disclosure have been described for purposes of illustration and that there are many possible variations without departing from the scope and spirit of the present disclosure. The disclosed various embodiments are not to be construed as limiting the disclosed spirit, but the true spirit and scope will be set forth in the following claims.

1. An unmanned aerial vehicle, comprising:
a main body comprising a battery and a flying power providing unit driven by power supplied from the battery to generate flying power; and
a connecting portion comprising a first charging terminal and a second charging terminal disposed in the main body and electrically connected to different polarities, respectively of the battery,
wherein the first charging terminal and the second charging terminal are disposed apart from each other at an outer surface of the connecting portion,
wherein at least a portion (hereinafter, referred to as an insertion portion) of the connecting portion is inserted into a recessed portion formed in a charging platform in a process in which the main body is seated in the charging platform,
wherein the first charging terminal and the second charging terminal are electrically connected to the first electrode and the second electrode, respectively spaced apart from each other in the charging platform in a process in which the insertion portion is inserted into the recessed portion, and
wherein the battery receives electrical energy from the charging platform to be charged, when the first charging terminal and the second charging terminal are electrically connected to the first electrode and the second electrode, respectively.

2. The unmanned aerial vehicle of claim 1, wherein the insertion portion has a shape of at least one selected from a cone, a truncated cone, a pyramid, a prismoid, and combinations thereof formed to face a direction of gravity,
wherein the recessed portion has a recessed shape corresponding to the insertion portion, and
wherein the insertion portion and the recessed portion have a shape corresponding to each other and the insertion portion is inserted to engage with the recessed portion in a process in which the insertion portion is inserted into the recessed portion and thus the first charging terminal and the second charging terminal are self-aligned with the first electrode and the second electrode, respectively to be electrically connected to each other.

3. An unmanned aerial vehicle automatic charging device for charging an unmanned aerial vehicle, wherein the unmanned aerial vehicle comprises:
a main body comprising a battery and a flying power providing unit driven by power supplied from the battery to generate flying power; and
a connecting portion comprising a first charging terminal and a second charging terminal disposed in the main body and electrically connected to different polarities, respectively of the battery,
wherein the first charging terminal and the second charging terminal are disposed apart from each other at an outer surface of the connecting portion,
wherein the automatic charging device comprises:
a charging platform in which the unmanned aerial vehicle may be seated;
a first electrode and a second electrode spaced apart from each other in the charging platform; and
a power supply unit that may be electrically connected to the first electrode and the second electrode,
wherein the charging platform comprises a seating portion having a shape in which the unmanned aerial vehicle may be seated and having at least one recessed portion into which at least a portion (hereinafter, referred to as an insertion portion) of the connecting portion may be inserted,
wherein the first electrode and the second electrode are disposed apart from each other at any one selected from a surface of the recessed portion, a surface of the seating portion adjacent to the recessed portion, and combinations thereof,
wherein the first charging terminal and the second charging terminal are electrically connected to the first electrode and the second electrode, respectively in a process in which the insertion portion is inserted into the recessed portion, and
wherein the first charging terminal and the second charging terminal are electrically connected to the first electrode and the second electrode, respectively and thus the battery may receive electric energy from the power supply unit to be charged.

4. The unmanned aerial vehicle automatic charging device of claim 3, wherein the insertion portion has a shape of at least one selected from a cone, a truncated cone, a pyramid, a prismoid, and combinations thereof formed to face a direction of gravity,
wherein the recessed portion has a recessed shape corresponding to the insertion portion, and
wherein the insertion portion and the recessed portion have a shape corresponding to each other and the insertion portion is inserted to engage with the recessed portion in a process in which the insertion portion is inserted into the recessed portion and thus the first charging terminal and second charging terminal are self-aligned with the first electrode and the second electrode, respectively to be electrically connected to each other.

5. The unmanned aerial vehicle automatic charging device of claim 3, wherein the insertion portion has a shape of a pyramid or a prismoid having the n (n is a natural number of 3 or more) number of side surfaces formed to face a direction of gravity,
wherein the recessed portion has a recessed shape corresponding to the insertion portion,
wherein the first charging terminal and the second charging terminal are disposed apart from each other in at least one side surface (hereinafter, referred to as a charging terminal disposition surface) of the n number of side surfaces of the insertion portion,
wherein the first electrode and the second electrode are disposed apart from each other to be opposite to the first charging terminal and the second charging terminal, respectively in at least one inner circumferential surface (hereinafter, referred to as an electrode disposition surface) of inner circumferential surfaces opposite to the charging terminal disposition surface among the n number of inner circumferential surfaces of the recessed portion into which the insertion portion is inserted, and
wherein the first charging terminal and the second charging terminal disposed at the charging terminal disposition surface are electrically connected to the first electrode and the second electrode, respectively disposed at the electrode disposition surface in a process in which the insertion portion is inserted into the recessed portion and thus the battery receives the electric energy from the power supply unit to be charged.

6. The unmanned aerial vehicle automatic charging device of claim 3, wherein the insertion portion has a shape of a cone or a truncated cone formed to face a direction of gravity,
wherein the recessed portion has a recessed shape corresponding to the insertion portion,
wherein the first charging terminal and the second charging terminal are disposed apart from each other based on a direction of gravity at a side surface of the insertion portion,
wherein the first electrode and the second electrode are disposed apart from each other to be opposite to the first charging terminal and the second charging terminal, respectively at an inner circumferential surface of the recessed portion, and
wherein the first charging terminal and the second charging terminal disposed at the side surface of the insertion portion are electrically connected to the first electrode and the second electrode, respectively disposed at the inner peripheral surface of the recessed portion in a process in which the insertion portion is inserted into the recessed portion and thus the battery receives the electric energy from the power supply unit to be charged.

7. The unmanned aerial vehicle automatic charging device of claim 3, wherein the insertion portion has a shape of a truncated cone or a prismoid formed to face a direction of gravity,
wherein the recessed portion has a recessed shape corresponding to the insertion portion,
wherein the first charging terminal and the second charging terminal are disposed apart from each other at a side surface of the insertion portion and a bottom surface, respectively of the insertion portion,
wherein the first electrode and the second electrode are disposed apart from each other to be opposite to the first charging terminal and the second charging terminal at an inner circumferential surface of the recessed portion and a bottom surface of the recessed portion, and
wherein the first charging terminal and the second charging terminal disposed at the side surface of the insertion portion and the bottom surface of the insertion portion are electrically connected to the first electrode and the second electrode, respectively disposed at the inner circumferential surface of the recessed portion and the bottom surface of the recessed portion in a process in which the insertion portion is inserted into the recessed portion and thus the battery receives the electric energy from the power supply unit to be charged.

8. The unmanned aerial vehicle automatic charging device of claim 3, wherein the connecting portion comprises a support portion having a protruding portion,
wherein the protruding portion performs a function of the insertion portion,
wherein the recessed portion has a recessed shape corresponding to the protruding portion,
wherein the first charging terminal and the second charging terminal are disposed apart from each other at a surface of the support portion having the protruding portion in a shape of enclosing the protruding portion,
wherein the first electrode and the second electrode are disposed apart from each other to be opposite to the first charging terminal and the second charging terminal, respectively, at a surface of the seating portion adjacent to the recessed portion, and
wherein the first charging terminal and the second charging terminal disposed at the surface of the support portion are electrically connected to the first electrode and the second electrode, respectively, disposed at the surface of the seating portion adjacent to the recessed portion in a process in which the insertion portion is inserted into the recessed portion and thus the battery receives the electric energy from the power supply unit to be charged.

9. The unmanned aerial vehicle automatic charging device of claim 3, wherein the connecting portion comprises a support portion in which a protruding portion is formed,
wherein the protruding portion performs a function of the insertion portion,
wherein the recessed portion has a recessed shape corresponding to the protruding portion,
wherein the first charging terminal and the second charging terminal are disposed apart from each other at a surface of the protruding portion and a surface of the support portion, respectively, having the protruding portion in a shape enclosing the protruding portion,
wherein the first electrode and the second electrode are disposed apart from each other to be opposite to the first charging terminal and the second charging terminal at an inner surface of the recessed portion and a surface of the seating portion, respectively, adjacent to the recessed portion, and
wherein the first charging terminal disposed at the surface of the protruding portion and the second charging terminal disposed at the surface of the support portion are electrically connected to the first electrode disposed at the inner surface of the recessed portion and the second electrode, respectively, disposed at the surface of the seating portion in a process in which the insertion portion is inserted into the recessed portion and thus the battery receives the electric energy from the power supply unit to be charged.

10. The unmanned aerial vehicle automatic charging device of claim 3, further comprising a solar cell panel disposed at a lower surface of the seating portion based on a direction of gravity,
wherein the seating portion is made of a light transmitting material, and the solar cell panel generates solar electric energy from sunlight reaching through the seating portion.

11. The unmanned aerial vehicle automatic charging device of claim 3, further comprising:
a controller; and
a weight sensor electrically connected to the controller and disposed at a lower surface of the seating portion based on a direction of gravity to detect whether the unmanned aerial vehicle is seated in the seating portion,
wherein the controller controls the power supply unit to supply the electric energy to the battery through the first electrode and the second electrode when the controller detects that the unmanned aerial vehicle is seated in the seating portion through the weight sensor.

12. The unmanned aerial vehicle automatic charging device of claim 3, further comprising:
a controller; and
a plurality of contact detection sensors electrically connected to the controller,
wherein in the seating portion, a plurality of recessed portions are disposed apart from each other,
wherein the plurality of contact detection sensors are disposed at an inside of the plurality of recessed portions, respectively or at a lower surface of the seating portion adjacent to the inside of the plurality of recessed portions, respectively, to detect whether the insertion portion is inserted into the recessed portion, and
wherein the controller determines whether the insertion portion is inserted into any one recessed portion (hereinafter, referred to as an insertion recessed portion) of the plurality of recessed portions through the plurality of contact detection sensors and controls the power supply unit to supply the electric energy to the battery through the first electrode and the second electrode corresponding to the insertion recessed portion.

13. The unmanned aerial vehicle automatic charging device of claim 3, further comprising:
a first communication terminal disposed apart from the first charging terminal and the second charging terminal at the outer surface of the connecting portion;
a second communication terminal disposed apart from the first electrode and the second electrode in the charging platform; and
a controller electrically connected to the second communication terminal,
wherein in the main body, an electronic device is disposed that can perform at least one selected from aerial image photographing, temperature detection, humidity detection, wind speed detection, position detection, and combinations thereof,
wherein the first communication terminal is electrically connected to the electronic device,
wherein the second communication terminal is disposed at any one selected from the surface of the recessed portion, the surface of the seating portion adjacent to the recessed portion, and combinations thereof, and
wherein the first communication terminal and the second communication terminal are electrically connected to each other in a process in which the insertion portion is inserted into the recessed portion and thus the controller may communicate with the electronic device.
